(19) United States
(12) Patent Application Publication
(10) Pub. No.: US 2015/0310108 A1
(43) Pub. Date: Oct. 29, 2015

(54) APPARATUS AND METHOD FOR COLLECTING MEDIA

(71) Applicant: Samsung Electronics Co., Ltd., Suwon-si (KR)

(72) Inventors: Hyeon-Jin KANG, Seoul (KR); Bo-Hyun KANG, Seoul (KR); Jong-Ho BANG, Suwon-si (KR); Sang-Ho LEE, Seongnam-si (KR); Joon-Young CHOI, Hwaseong-si (KR)

(21) Appl. No.: 14/698,245

(22) Filed: Apr. 28, 2015

(30) Foreign Application Priority Data
Apr. 28, 2014 (KR) 10-2014-0050816

(51) Int. Cl. G06F 17/30

(52) U.S. Cl. CPC G06F 17/30864; G06F 17/30601; G06F 17/30554

(57) ABSTRACT

Apparatuses and methods for collecting medium data items are provided. The apparatuses include a portable terminal which collects medium data items determined to be related to a particular event under a search condition according to an occurrence time of the particular event and classifies the collected medium data items records for the particular event.

### CROSS-REFERENCE TO RELATED APPLICATION(S)

This application claims the benefit under 35 U.S.C. §119(a) of a Korean patent application filed on Apr. 28, 2014, in the Korean Intellectual Property Office and assigned Serial number 10-2014-0050816, the entire disclosure of which is hereby incorporated by reference.

### TECHNICAL FIELD

The present disclosure relates to apparatuses and methods for collecting medium data items related to a particular event.

### BACKGROUND

The Internet, which is a human centered connectivity network where humans generate and consume information, is now evolving to the Internet of Things (IoT) where distributed entities, such as things, may exchange and process information without human intervention. An Internet of Everything (IoE), which is a combination of the IoT technology and the Big Data processing technology through connection with a cloud server, has emerged therefrom.

As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create new benefits to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

The growth of IT technologies has led to the flourishing market of various portable electronic devices (hereinafter, “portable terminals”) that enable use of communication services free of limitations on place, in an easy-to-carry way. This created the demand for media, games, or other content services.

For example, the smartphone, a type of portable terminal, may offer the user a diversity of services including playback of music and videos, shopping, and financial transactions, as well as traditional voice call services.

Diversified services using portable terminals have increased the demand for an easier search of desired information. Accordingly, the search function on the portable terminal tends to be reinforced.

For example, a typical way to search using a portable terminal is to search for related media with the title or additional descriptions given by the media publisher. In other words, the relationship between the media published online and an event has been determined by comparing the titles and descriptions of the media with the keyword of a query. However, searches using the title or additional description, when conducted on the text-based material, are easy, but are not an appropriate way for music, movie, videos or other media.

Another typical way to do a search is to make use of sample images. For example, the media relevant to the same event may be searched by identifying media with a partial or whole image consistent with the sample image.

However, the media searching scheme utilizing sample images determines the similarity between one or more frames constituting the media and the sample image input for a search, and thus, this scheme requires significant computation.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for collecting medium data items related to a particular event using at least one of a time and place related to the particular event.

Another aspect of the present disclosure is to provide an apparatus and method for collecting medium data items related to an event when the event occurs.

Another aspect of the present disclosure is to provide an apparatus and method for collecting medium data items predicted to be related to a particular event based on at least one of a time and location.

Another aspect of the present disclosure is to provide an apparatus and method for collecting medium data items related to a particular event using at least one of the time and place where the medium data items have been recorded.

Another aspect of the present disclosure is to provide an apparatus and method for classifying the medium data items recorded in a database per event according to a recording time or recording place or both.

Another aspect of the present disclosure is to provide an apparatus and method for collecting medium data items, classifying medium data items not classified per event based on at least one of the occurrence time and location information.

In accordance with an aspect of the present disclosure, a method for collecting a medium data item by a portable terminal is provided. The method includes collecting medium data items determined to be related to a particular event under a search condition according to an occurrence time of the particular event and classifying the collected medium data items records for the particular event.

In accordance with another aspect of the present disclosure, a method for displaying a medium data item by a portable terminal is provided. The method includes predicting an occurrence time and location of a particular event for which medium data items are to be collected, displaying information on at least one medium data item collected using the predicted time and location on an electronic map displayed on a screen with respect to a location where the particular event has occurred according to the predicted location, and if the displayed information is selected, playing a medium data item corresponding to the selected information on the map.

In accordance with another aspect of the present disclosure, an apparatus for collecting a medium data item is provided. The apparatus includes a communication module configured to provide a communication function through a network and a control module configured to collect medium data items determined to be related to a particular event under a search condition according to an occurrence time of the particular event and classify the collected medium data items records for the particular event.

In accordance with another aspect of the present disclosure, a portable terminal displaying a medium data item is provided. The portable terminal includes a displaying unit and a control module configured to predict an occurrence time and location of a particular event for which medium data items are to be collected, display information on at least one medium data item collected using the predicted time and location on an electronic map displayed on a screen with respect to a location where the particular event has occurred according to the predicted location, and if the displayed information is selected, play a medium data item corresponding to the selected information on the map.

According to an embodiment of the present disclosure, medium data items related to a desired event may be collected with reduced effort using the occurrence time and location information. Further, it may be possible to easily detect medium data items related to a particular event targeting medium data items not assigned special descriptions or titles.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view schematically illustrating a procedure for collecting medium data items according to an embodiment of the present disclosure;

FIG. 2 is a view illustrating an example of a wireless communication system according to an embodiment of the present disclosure;

FIG. 3 is a block diagram illustrating a configuration for searching for medium data items according to an embodiment of the present disclosure;

FIG. 4 is a view illustrating an example of a scenario of searching an internal storage medium for medium data items according to an embodiment of the present disclosure;

FIG. 5 is a view illustrating an example of a scenario of searching an external storage medium for medium data items according to an embodiment of the present disclosure;

FIG. 6 is a view illustrating an example of displaying a video group for an event according to an embodiment of the present disclosure;

FIG. 7 is a view illustrating an example of extending a displayed screen area using a zoom-out function according to an embodiment of the present disclosure;

FIG. 8 is a view illustrating an example of selecting medium data items searched corresponding to a particular event according to an embodiment of the present disclosure;

FIG. 9 is a view illustrating an example of playing a selected medium data item through an auxiliary screen according to an embodiment of the present disclosure;

FIG. 10 is a view illustrating an example of requesting to change from the auxiliary screen on which the medium data item is being played to the full screen according to an embodiment of the present disclosure;

FIG. 11 is a view illustrating an example of playing a selected medium data item through the full screen according to an embodiment of the present disclosure;

FIG. 12 is a view illustrating an example of classifying medium data items collected per event in an internal storage medium according to an embodiment of the present disclosure;

FIG. 13 is a view illustrating an example of determining that a record is an event-related record in case there is a single recording entity according to an embodiment of the present disclosure;

FIG. 14 is a view illustrating an example of determining that a record is an event-related record in case there are multiple recording entities according to an embodiment of the present disclosure;

FIG. 15 is a view illustrating an example of identifying the location and/or time information of an event using information provided from a third party according to an embodiment of the present disclosure; and

FIG. 16 is a view illustrating a flow of control for searching for medium data items regarding a particular event by a portable terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

A scheme for searching for an event-related medium using the time when an event occurs and/or location information and collecting information regarding the event-related medium by the search is described below in detail.

The event-related medium means a medium generated in relation to the event. The medium includes an audio, a picture with one frame, and a video with multiple frames.

The time when the event occurs and/or the location information are information that allow for identification as to where and when the event occurs. For example, assume that the event is filming of the movie “Avengers 2,” on the Mapo Bridge from 6 AM to 5:30 PM, Mar. 30, 2014. The time information of the event may be, “from 6 AM to 5:30 PM, Mar. 30, 2014,” and the location information may be, “Mapo bridge”.

In the case, among the recorded media, the medium recorded from 6 AM to 5:30 PM, Mar. 30, 2014, near the Mapo Bridge is searched, according to an embodiment of the present disclosure. By way of example, the respective time and/or location information of the media recorded are identified to search for the medium related to the event, the filming of Avengers 2 at Mapo Bridge.

Hereinafter, various embodiments of the present disclosure are described in detail with reference to the accompanying drawings.

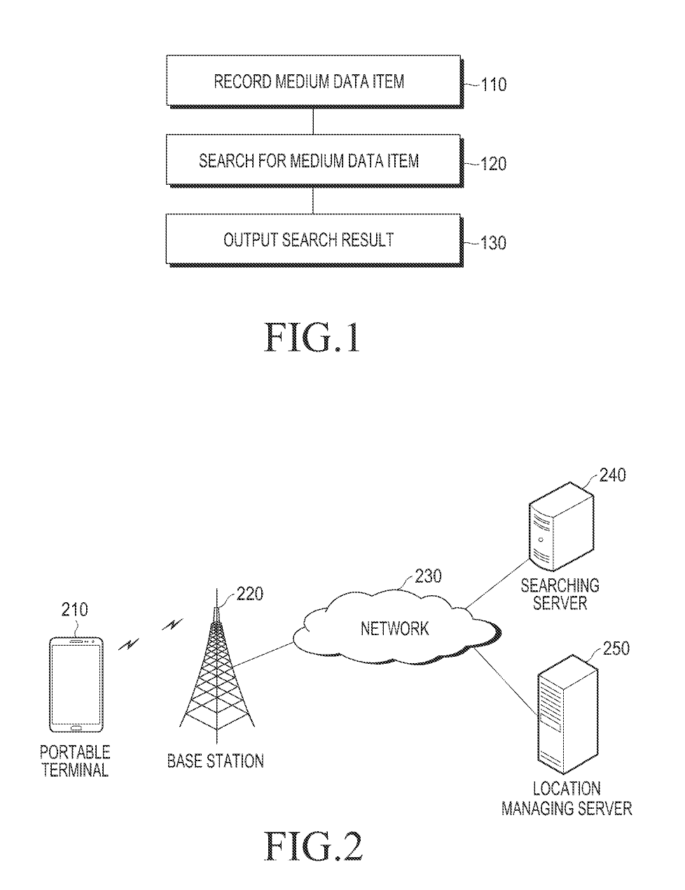

FIG. 1 schematically illustrates a procedure for collecting medium data items according to an embodiment of the present disclosure.

Referring to FIG. 1, collection of desired medium data items includes recording generated medium data items, searching for a medium data item related to a particular event, and outputting a result of the search.

According to an embodiment of the present disclosure, a predetermined recording entity records the generated medium data items at operation 110. The predetermined recording entity may be a portable terminal that may generate medium data items. There may be one or more recording entities for recording the medium data items. The recording entity may generate, as the medium data items, an audio, a picture that is a medium including one frame, or a video that is a medium including multiple frames.

The recording entity may record additional information, such as time, location, title, description, and tag, together with the medium data items. The additional information does not necessarily require all the information exemplified above. The additional information, for example, might include only the time information and title. At least one information including the additional information may be extracted from the generated medium data items. For example, the generated medium data items may include the time and/or location information on the filming or recording (hereinafter, referred to as, “recording time and/or location information”, for ease of description). In this case, the recording time and/or location information may be obtained from the medium data items generated for recording and may be recorded separately.

As an example, assume medium data items generated by video recording for “five minutes” from 10 a.m., Nov. 12, 2014. The generated medium data items may be said to be a record from 10:00 a.m., 2014-11-12, to 10:05 a.m., 2014-11-12. Accordingly, the medium data items may contain time information indicating “10:00 a.m., 2014-11-12 to 10:05 a.m., 2014-11-12”.

As an embodiment of the present disclosure, there may be the case where the name is arbitrarily given by the recording entity for the generated medium data items. If the arbitrarily given name matches a particular format, the recorded time information may be extracted from the arbitrarily given name. For example, in a case where the medium data item has a name of “20140128_{—}114605.mp4”, the first eight letters of the name might mean the year, month, and date when the medium data item was created, and the remaining eight letters might mean the time when the medium data item was created. Accordingly, it can be seen that the medium data item whose name is “20140128_{—}114605.mp4” was created at 11:46:05 a.m., 2014-01-28.

As another example, such a name as “SEOUL_{—}20140128_{—}114605.mp4” may contain location information as well as time information. In this case, the information on the time and location where the medium data item was created may be extracted from the medium data item. For example, it can be recognized that the medium data item was created at 11:46:05 a.m., 2014-01-28.

Unlike the above described examples, the medium data items might not contain time and/or location information. In such case, whenever generated medium data items are recorded, the information on the time and location of the recording may be separately recorded.

A predetermined searching entity searches for medium data items relating to a particular event at operation 120. The predetermined searching entity may be a portable terminal that may search for medium data items. The predetermined searching entity may be the same as the recording entity that has recorded the medium data items. The medium data items to be searched may include an audio and/or a picture that is a medium including one frame and/or a video that is a medium including multiple frames.

The searching entity, if an event for which medium data items are to be searched is determined, obtains the information on the time and/or location where the determined event is predicted to has occurred (hereinafter, denoted “occurrence time and/or location information,” for ease of description). The searching entity searches for the medium data items relating to the event from medium data items recorded, using the obtained occurrence time and/or location information.

For example, the searching entity may compare the recording time and/or location information of the recorded medium data items with the occurrence time and/or location information of the event and may detect the medium data items with a consistent or close value for the compared information as the medium data items relating to the event.

The method by which the searching entity compares the occurrence time and/or location information of the event with the recording time and/or location information of the recorded medium data items may vary depending on whether there is a single or multiple recording entities.

As an example, in the case that there is a single recording entity, there may be overlap in recording time between the recorded medium data items. Assuming that there are two recorded medium data items, the recording times of the two medium data items may be “10:00 to 10:10” and “10:05 to 10:15”, respectively, which have an overlapping time interval (10:05 to 10:10).

Further, in the case that there is a single recording entity, the probability that medium data items are recorded is relatively low due to diversified events as compared with when there are multiple recording entities. In other words, in the case that there is a single recording entity, such an occasion would not frequently happen where depth information for different events are recorded.

As an example of a detection method according to such a feature, the searching entity may detect a medium data item with a recording time close to the occurrence time of the event, or a medium data item with a recording location close to the occurrence location of the event. However, if the degree of closeness of a medium data item is out of a threshold range, it is preferable to consider that this medium data item has nothing to do with the searched for event.

There may be a number of methods for determining the threshold range. By way of example, the threshold range for the time may be set to a day, and if at least one event happens within the day, the medium data items recorded on the day may be deemed to originate from one event that has happened on that day. However, if the threshold range for the time has been set to one day, but if there are multiple event information within the day, the medium data items recorded on the day should be considered record for the event close in time or location.

As another example, in the case that there are multiple recording entities, although the medium data items have been recorded by different recording entities, the medium data item recorded for the same event should be able to be detected from among the recorded medium data items.

The medium data items recorded by the multiple recording entities may also have overlapping time intervals. Further, upon recording medium data items by the multiple recording entities, it is common to use a media sharing service, such as YouTube™, Naver™, or Daum™. The media sharing service limits the maximum permissible play time (for example, 10 to 15 minutes per video clip) and needs to be considered for a tolerance of location information. For example, the tolerance of the location information may be more or less than 10 meters for the Global Positioning System (GPS), up to 200 meters upon use of WiFi, and possibly up to thousands of meters upon use of Mobile Identification (ID).

Accordingly, in the case of the media sharing service in which medium data items are recorded by multiple recording entities, medium data items may be detected by the following procedure according to the characteristics.

First, the searching entity compares the occurrence location of the event with the recording location of the medium data items and identifies the medium data items recorded within, at least, 10 meters or more or less of the occurrence location of the event. Unless there are no medium data items recorded within at least 10 meters or more or less, the searching entity may extend its search area to a few thousands of meters and identify whether there are medium data items regarding the desired event.

Next, the searching entity performs additional detection on medium data items recorded within a time interval, for example, up to 15 minutes before and after the occurrence time of the event among the medium data items detected by the location-based ID.

The threshold range for the time and/or location for the detecting operations may vary per event regardless of whether the same or different recording entities involve, and the method is not particularly limited.

If the situation where the records have been distributed by time and location has been identified, the records meeting both the threshold range set for time (degree of closeness to time information) and the threshold range set for location (a distance from the location of the event) may be identified. In other words, medium data items predicted to be ones for the desired event may be detected by comparison of location information and comparison of time information.

The predetermined searching entity outputs a result of the search on the medium data items of the particular event in various formats at operation 130. A predetermined searching entity may be a portable terminal that may play the medium data items. The searching entity outputting the search result of the medium data items may be the same as the recording entity recording medium data items and the searching entity searching for medium data items. The search result output by the searching entity may include a thumbnail image and recording time and/or location information corresponding to each of the medium data items searched for the particular event.

For example, the searching entity may display a map with a predetermined radius from its own location or the occurrence location of the event, and may display the search result on the displayed map. The searching entity may repeatedly display the frame interval corresponding to the event and the location where each corresponding medium data item has been recorded on the map.

The searching entity displays the point where the event has actually occurred (the occurrence location of the event) together with the point where each medium data item has been recorded according to the search result (the recording location). The search result is displayed in such a manner that it may be easily determined which location each searched medium data item has been recorded with respect to the occurrence location of the event.

In the case that the searched medium data item is a video, the searching entity, upon displaying the search result, may display the result starting with a first portion of the interval associated with the event.

The searching entity may classify and display the medium data items with respect to the event through an application that enables the viewing of pictures and videos based on the search result. The searching entity, if an event name has been assigned to one medium data item, may assign the same event name to remaining medium data items belonging to the event category.

There may be an occasion where an event may be explicitly assigned to medium data items recorded by the user. For example, upon or before or after recording a medium data item, a title, description, and tag may be assigned to the medium data item. In such a case, even though separate information is not assigned to the medium data items considered to be recorded according to the same event, the title, description, and tag that were assigned before or are to be assigned later may be automatically assigned or the user may be prompted to assign to the medium data items.

As an example, if medium 1, medium 2, and medium 3 are thought to have been recorded of the same event, but only medium 2 has been assigned a title, description, and tag, the searching entity may assign the same title, description, and tag as those assigned to medium 2 to medium 1 and medium 3 as well.

To perform the above-described operation according to the embodiment of the present disclosure, standards for the time and/or location information need to be previously agreed for the search to be easily done. To that end, a need exists for a scheme for making the occurrence location of the event and the recording locations of the medium data items consistent with previously agreed standards.

For example, if a region name, a building name, and a business name have been interchangeably used for the occurrence location and/or recording location, it would not be easy to search for the medium data items regarding the event. In this case, if the occurrence location or recording location defined by the region name, building name, and business name are converted into a common format such as latitude and longitude information and used in a consistent way, it would be easier to search for the medium data item for the particular event.

Accordingly, if the user inputs information regarding an event for which medium data items are requested to be searched, the searching entity obtains the occurrence time and/or location information of the event. As an example, the searching entity may search for schedule information input by the user to identify the occurrence time and location information of the event. For example, searching a musician's name and a city may return a corresponding concert tour date, show time, and performance venue (location) of a performance by that musician in that city.

In this case, if the location information is not of the agreed standard, i.e., is a region name, building name, or business name, and is not in the format of the geographical information by the latitude and longitude, the searching entity should convert the identified location information into the latitude and longitude information. The conversion of the location information into the latitude and longitude information may use an internal database or an external service.

The searching entity may identify the location and/or time information of the event through a service offered by a third party, and this enables acquisition or prediction of the location and/or time information with the highest correlation with the user's input.

FIG. 2 illustrates an example of a wireless communication system according to an embodiment of the present disclosure.

Referring to FIG. 2, a portable terminal 210 generates medium data items related to a particular event by recording sound, taking a picture, or recording video. The portable terminal 210 may record the generated medium data items together with additional information. The additional information may include ID information for identifying the event, time information (occurrence time information) and location information. The location information preferably has the format that enables easy determination as to whether it is at the same location or near through mutual comparison. For example, the location information may be latitude and longitude information. However, as the location information, a building name or address may be recorded as well. In this case, as necessary, the building name or address may be converted into the corresponding latitude and longitude information, and the converted latitude and longitude information may be used.

The portable terminal 210 may record the medium data items generated regarding a particular event in an internal or external storage medium.

The portable terminal 210 may collect the medium data items related to the particular event based on at least one of the occurrence time and location information of the particular event. The occurrence time and location information of the particular event may be extracted or predicted from the medium data items related to the particular event or information input in relation to the particular event.

As an example, at least one of the occurrence time and location information of the particular event may be extracted or predicted from the information included in at least one medium data item related to the particular event. As another example, at least one of the occurrence time and location information of the particular event may be extracted or predicted from the additional information separately recorded corresponding to at least one medium data item. As still another example, at least one of the occurrence time and location information of the particular event may be extracted or predicted from the information input in relation to the particular event. The information input in relation to the particular event may be ID information identifying the particular event.

Here, the “extract” means directly obtaining the occurrence time and location information of the particular event from the information regarding the particular event, and the “predict” means indirectly obtaining the occurrence time and location information of the particular event using information regarding the particular event (hereinafter, denoted “additional information”).

For example, in the case that the additional information includes the occurrence time and location information of the particular event, the portable terminal 210 extracts the occurrence time and location information of the particular event from the information related to the particular event.

However, in the case that the additional information includes reference information that may help to predict the occurrence time and location information of the particular event, the portable terminal 210 predicts the occurrence time and location information of the particular event using the reference information. As an example, in case event information such as “Chulsoo and Younghee's wedding” or “Samsung-dong Helicopter Crash” is provided as reference information, the portable terminal 210 may predict at least one of the occurrence time and location information of the event by searching the medium data items or schedule information recorded therein or the database of an external server using the reference information. The portable terminal 210 may selectively or together search the data recorded therein and the database in the external server. For example, in the case of a newsworthy event such as a helicopter crash, searching may return the probable location and date of the desired event with a high degree of confidence.

It is preferable to use, as the location information extracted or predicted for the particular event, information that may guarantee reliability in designating a location such as a latitude and longitude. In other words, the location information such as latitude and longitude should be used to increase reliability in determination as to whether the multiple medium data items stem from the same event through comparison of location information of the multiple medium data items.

Accordingly, if the extracted or predicted location information is not a desired type of information, e.g., latitude and longitude, the portable terminal 210 may still obtain the desired type of location information using the extracted or predicted location information.

As an example, if event information “Chulsoo and Younghee's wedding” is input, the portable terminal 210 searches the recorded schedule information and extracts location information “Seocho Catholic Church”. The portable terminal 210, since the location information is not of a desired type, may obtain the latitude and longitude information of the Seocho Catholic Church from an internal database or an external database managing the latitude and longitude per location. The external database may be managed by a location managing server 250. Communication with external servers such as a searching server 240 and a location managing server 250 may be conducted through a network 230.

As another example, if event information “Samsung-dong Helicopter Crash” is input, the portable terminal 210 provides the “Samsung-dong Helicopter Crash” information to an external searching server 240. The searching server 240 may obtain, from the managing server 250, the latitude and longitude information of the location where the event has occurred with the information “Samsung-dong Helicopter Crash”.

The portable terminal 210 searches for (or collects) the medium data items relating to the particular event from among the medium data items recorded therein using the search information generated by the event information or the occurrence time and location information extracted or predicted. The portable terminal 210 may request the searching server 240 to search for the medium data items regarding the relevant event using the search information generated by the event information or the occurrence time and location information extracted or predicted and may collect its desired medium data items from the result of the search.

The portable terminal 210 may classify and manage at least medium data item collected as material corresponding to the event. The portable terminal 210 may apply the event-related information assigned to at least one medium data item among the medium data items classified corresponding to the particular event to remaining medium data items in the same manner.

According to an embodiment of the present disclosure, the portable terminal 210 may include a communication module and a control module. The communication module may provide a function for performing communication with another device through a network. For example, the communication module may transfer, to the external server, information input in relation to the particular event under the control of the control module. The communication module may receive, from the external server, the occurrence time and occurrence location information of the particular event extracted with the transferred information.

The control module may perform an overall operation for collecting medium data items determined to be related to the particular event under search conditions according to the occurrence time of the particular event. Further, the control module may classify the collected medium data items as records regarding the particular event.

The control module may obtain the occurrence time of the particular event or the occurrence location of the particular event using the data recorded in relation to the particular event or the information input in relation to the particular event.

According to an embodiment of the present disclosure, in case the collection of medium data items has been set to the same recording entity, the control module may collect at least one medium data item recorded at the time within the threshold range set with respect to the occurrence time of the particular event among the medium data items recorded by the same recording entity. The control module may collect only the medium data items recorded at the location within the threshold range set with respect to the occurrence location of the particular event from the at least one medium data item collected at the occurrence time. Here, the threshold range with respect to the occurrence time of the particular event and the threshold range with respect to the occurrence location of the particular event may be set according to the type of the particular event.

According to an embodiment of the present disclosure, in the case that the collection of medium data items has been set to multiple recording entities, the control module may collect medium data items recorded at the location within the threshold range set with respect to the occurrence location of the particular event, and at the time within the threshold range set with respect to the occurrence time of the particular event, from among the medium data items recorded by the multiple recording entities. In this case also, the threshold range with respect to the occurrence time of the particular event and the threshold range with respect to the occurrence location of the particular event may be set according to the type of the particular event.

When predicting the place where the particular event has occurred using the data recorded in relation to the particular event, the control module may obtain the latitude and longitude representing the location where the particular event has occurred based on the information regarding the predicted place.

The control module may assign the information assigned to one of the medium data items collected for the particular event to the other medium data items in the same manner.

The base station 220 provides wireless communication services based on radio channels with the portable terminal 210.

The searching server 240 may search for medium data items predicted to have been recorded for the particular event based on the search information provided by the portable terminal 210 and may provide a result of the search to the portable terminal 210. As an example, the searching server 240 may provide the portable terminal 210 with the search result including the time of generation (or time of recording) of each searched medium data item, the location information of recording, and thumbnail data.

The portable terminal 210 may display the location where the event has occurred and the location and time when each medium data item searched by the searching server 240 has been recorded on the map using a thumbnail screen according to the medium data item based on the search result provided by the searching server 240.

The searching server 240 may provide the portable terminal 210 with medium data items selected by the portable terminal 210 among the medium data items transferred as the search result. The portable terminal 210 may record, manage, or play the medium data items provided by the searching server 240 as medium data items corresponding to the event.

The location managing server 250 manages the location information defined with a latitude and longitude corresponding to the region name, building name, or business name. The location managing server 250, when requested to provide location information by the portable terminal 210 or the searching server 240, provides the portable terminal 210 or the searching server 240 with the location information defined with the latitude and longitude corresponding to the region name, building name, or business name.

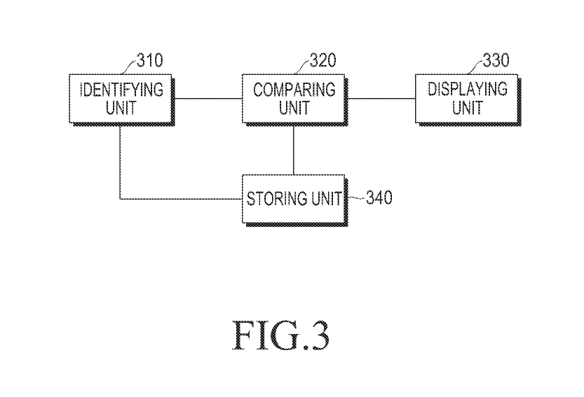

FIG. 3 is a block diagram illustrating a configuration for searching for medium data items according to an embodiment of the present disclosure.

Referring to FIG. 3, an identifying unit 310 generates a search equation for a particular event. The identifying unit 310 should be able to obtain information on the particular event to generate the search equation for the particular event.

The identifying unit 310 may obtain the information regarding the particular event based on the information obtained from a particular medium data item or input from the outside. As an example, if event information “Samsung-dong Helicopter Crash” has been input from the outside, the identifying unit 310 may obtain “a helicopter has crashed in Samsung-dong” as information regarding the particular event. As another example, if event information “Chulsoo and Younghee's wedding” has been input, the identifying unit 310 may obtain “Chulsoo and Younghee's wedding” as information regarding the particular event.

The identifying unit 310, upon obtaining the information regarding the particular event, obtains the occurrence time and location information of the event. The media device may obtain the occurrence time and location information of the event from, e.g., a record or schedule information regarding the event or relevant medium data item.

The identifying unit 310 generates the search equation for the particular event with the particular event information and the occurrence time and/or location information of the particular event obtained. The identifying unit 310 may provide a comparing unit with the generated search equation or the occurrence time and/or location information of the particular event obtained.

The comparing unit 320 may search for medium data items for the particular event based on the occurrence time and/or location information of the particular event or the ID information for identifying the particular event. The comparing unit 320 collects desired medium data items according to the search result. For example, the comparing unit 320 may search for medium data items following various scenarios. This is described below in further detail.

In another scheme, the comparing unit 320, upon obtaining the information regarding the particular event, may execute a search using the information regarding the particular event and may classify only medium data items related to the particular event from various types of data obtained through the search. In this case, the comparing unit 320 may generate the search equation regarding the event only with the information regarding the particular event. The comparing unit 320 may classify medium data items related to the particular event from the data obtained through the search using the occurrence time and location information of the particular event.

A storing unit 340 stores medium data items generated with recorded pictures or videos. The generated medium data items may be stored in a storing unit 340, together with additional information including the time and/or location information related to the recording. The additional information may contain event information related to the recorded pictures and videos.

The medium data items may be recorded in an external storage medium. This means that the medium data items such as recorded pictures or videos are registered in a portal site or Social Networking Service (SNS) in response to the user's request.

Typically, if medium data items are recorded in the internal storage medium, i.e., the storing unit 340, the medium data items are likely to be records that have been generated by a single recording entity, and if medium data items are recorded in the external storage medium, the medium data items are likely to be records that have been generated by multiple recording entities. However, the above rule does not always apply. In other words, even medium data items recorded in the internal storage medium may be the ones recorded by multiple recording entities, while even medium data items recorded in the external storage medium may be the ones recorded by an independent recording entity.

A displaying unit 330 may display a map for the region where the event has occurred based on the search result made by the comparing unit 320 and may display the thumbnail image and time information of each medium data item at the location indicated by the location information included in the search result. As an example, the displaying unit 330, if having displayed the search result with respect to the location where the event has occurred, may additionally display a direction of recording from the point displayed corresponding to each searched medium data item toward the location where the event has occurred.

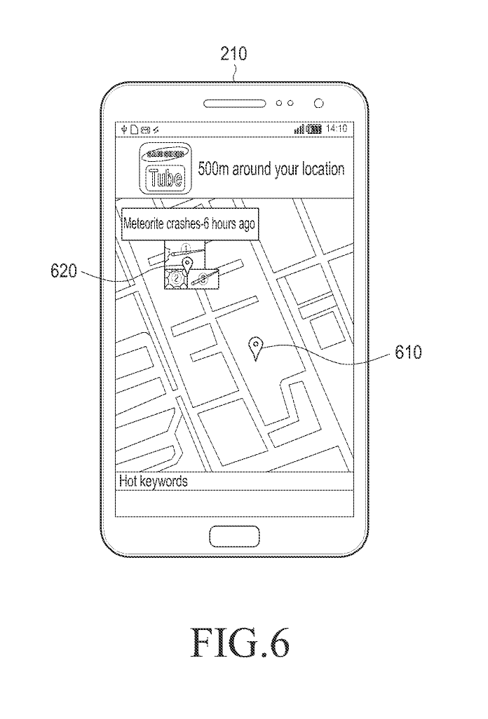

For example, the displaying unit 320 may display the search result as shown in FIGS. 6 to 11. This is described below in further detail.

As an example, the identifying unit 310 and the comparing unit 320 may be configured in a single control module. In this case, the control module may process the functions of the identifying unit 310 and the comparing unit 320 instead of the units 310 and 320. The control module may further include a storing unit 340.

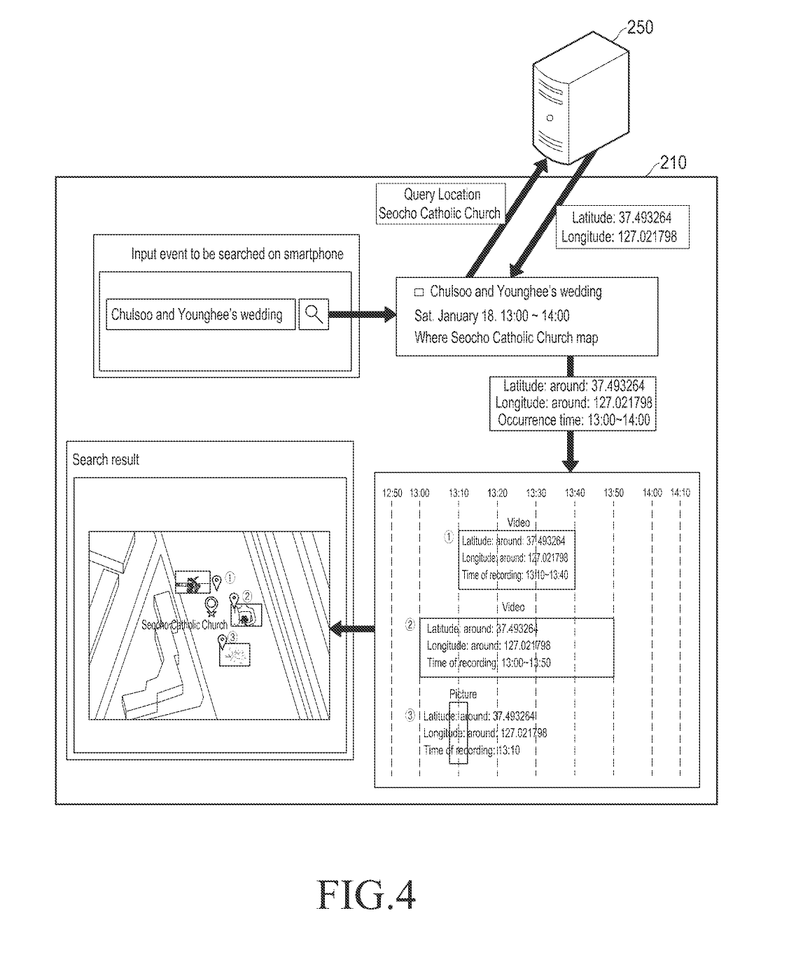

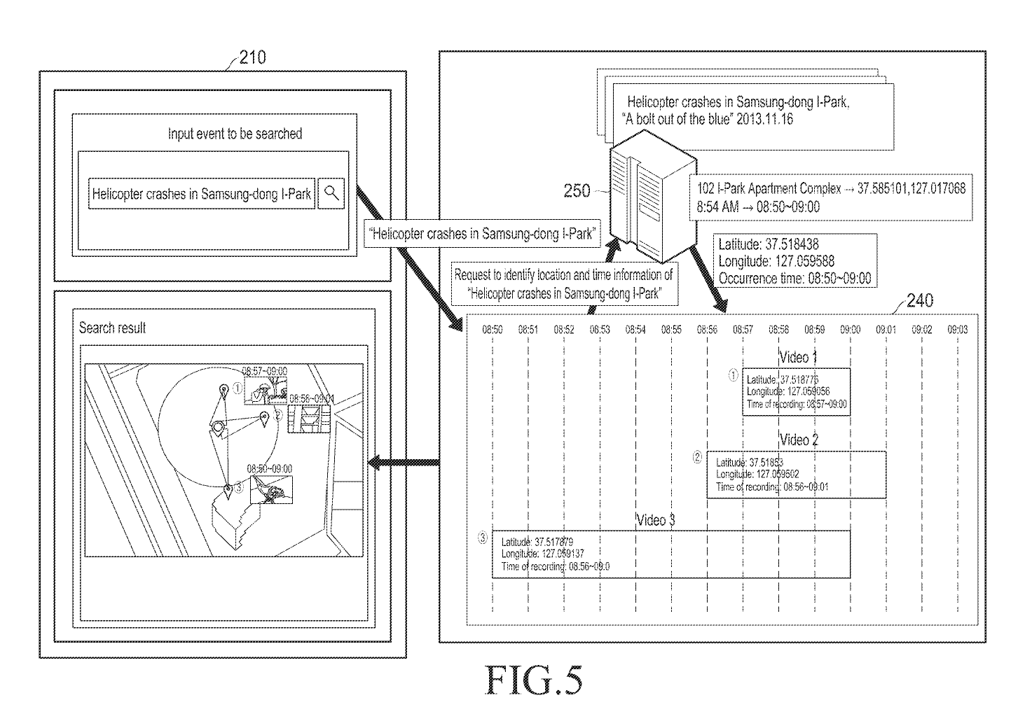

FIGS. 4 and 5 illustrate examples of scenarios of searching and collecting medium data items according to various embodiments of the present disclosure.

FIG. 4 illustrates an example of a scenario of searching an internal storage medium for medium data items according to an embodiment of the present disclosure.

Referring to FIG. 4, the portable terminal 210 activates an input window for receiving an event to be searched in response to a medium search request. If, after event information “Chulsoo and Younghee's wedding” is input through the input window, an icon for requesting a search is pressed, the portable terminal 210 searches the internal storage medium for the schedule information for the “Chulsoo and Younghee's wedding” information and extracts the location information “Seocho Catholic Church” and the time information “Sat. January 18, 13:00 to 14:00”.

The portable terminal 210, since the location information is not of the desired type, may obtain the latitude and longitude information of the Seocho Catholic Church from its internal database or from an external database. For example, the latitude and longitude information obtained for Seocho Catholic Church is (latitude: 37.493264, longitude: 127.021798).

The portable terminal 210 searches for medium data items filmed or recorded within the time interval “Sat. January 18, 13:00˜14:00” at the location near (latitude: 37.493264, longitude: 127.021798). In this case, the search may be done for the medium data items recorded in the internal storage medium.

Shown in the figures is an example in which three medium data items (videos 1 and 2, and picture 3) are searched. Video 1 is a medium data item filmed or recorded from 13:10 to 13:40 at the location (latitude: 37.493018, longitude: 127.021769). Video 2 is a medium data item filmed or recorded from 13:00 to 13:50 at the location (latitude: 37.492922, longitude: 127.021965). Picture 3 is a medium data item filmed or recorded at 13:10 at the location (latitude: 37.492715, longitude: 127.021804). The latitude and longitude coordinates of each of the three medium data items returned in the search are within the threshold distance of the location of Seocho Catholic Church, (latitude: 37.493264, longitude: 127.021798).

The portable terminal 210 displays a map for the region where the event has occurred based on the search result made by the comparing unit 210 and displays the thumbnail image and time information of each medium data item at the location indicated by the location information included in the search result. As an example, the portable terminal 210 may additionally display a direction of recording of each searched medium data item.

FIG. 5 illustrates an example of a scenario of searching an external storage medium for medium data items according to an embodiment of the present disclosure.

Referring to FIG. 5, the portable terminal 210 activates an input window for receiving an event to be searched in response to a medium search request. If, after event information “Samsung-dong Helicopter Crash” is input through the input window, an icon for requesting a search is pressed, the portable terminal 210 provides the information “Samsung-dong Helicopter Crash” to the searching server 240.

The searching server 240 requests the managing server 250 to identify the occurrence location and time information of the event “Samsung-dong Helicopter Crash”.

The location managing server 250 may extract the latitude and longitude information corresponding to “Samsung-dong” that may be obtained from the information “Samsung-dong Helicopter Crash” provided from the searching server 240 and may provide the same to the searching server 240.

The location managing server 250 collects material, such as news articles, through a search with the information “Samsung-dong Helicopter Crash” provided from the searching server 240 and may obtain the occurrence time and/or location information of the event “Samsung-dong Helicopter Crash” through the collected material. The obtained time and/or location information may be relatively exact information as compared with the above example. An example is shown in which as the time and location information, the location information (latitude: 37.518438, longitude: 127.059588) and the occurrence time information “08:50˜09:00” is obtained. The location managing server 250 may provide the obtained time and/or location information to the searching server 240.

The searching server 240 searches for medium data items predicted as medium data items regarding the event “Samsung-dong Helicopter Crash” using the time and location information provided from the location managing server 250. For example, the medium data items filmed or recorded at the time around “08:50 to 09:00” at the location within the threshold distance of (latitude: 37.518438, longitude: 127.059588).

Shown in the figures is an example in which three medium data items (videos 1, 2, and 3) are searched. Video 1 is a medium data item filmed or recorded from 08:57 to 09:00 at the location (latitude: 37.518776, longitude: 127.059056). Video 2 is a medium data item filmed or recorded from 08:56 to 09:01 at the location (latitude: 37.51853, longitude: 127.059502). Video 3 is a medium data item filmed or recorded from 08:50 to 09:00 at the location (latitude: 37.517879, longitude: 127.059137).

The searching server 240 provides the search result of the portable terminal 210. For example, the result provided from the searching server 240 to the portable terminal 210 may be the time and location information corresponding to each searched medium data item and thumbnail information. The thumbnail information may be image information briefly introducing the video according to the medium data item. The searching server 240 may transfer, to the portable terminal 210, the occurrence time and location information of the “Samsung-dong Helicopter Crash” provided from the location managing server 250.

Upon receiving the search result from the searching server 240, the portable terminal 210 may display a map for the region where the event has occurred based on the search result made by the comparing unit 240 and may display the thumbnail image and time information of each medium data item at the location indicated by the location information included in the search result. As an example, the portable terminal 210 may additionally display a direction of recording of each searched medium data item.

FIG. 6 illustrates an example of displaying a video group for an event according to an embodiment of the present disclosure. FIG. 6 illustrates an example of displaying thumbnail images corresponding to three medium data items filmed and recorded around the location 620 where the event “meteorite crash” has occurred on the map screen within a radius of 500 m of the user's current location 610.

The portable terminal 210 may set or vary the area for displaying the medium data items searched around the location 620 where the event has occurred. In the figure, the area where the medium data items are displayed has been shaded.

If the user extends the shaded area, the information on the medium data items recorded in the area added by the extension among the medium data items searched earlier may be additionally displayed. Further, if the user shrinks the shaded area, the information on the medium data items in the area excluded by the shrinkage may be removed from being displayed.

The portable terminal 210, when the user extends the shaded area, may provide the searching server 240 with the information on the area varied by the extension. In this case, the searching server extends the search range (search area) by the varied area and searches for medium data items recorded or filmed in the extended search range. The searching server 240 provides the portable terminal 210 with the result of the additional search. The portable terminal 210 reconfigures the screen based on the result of the additional search provided from the searching server 240.

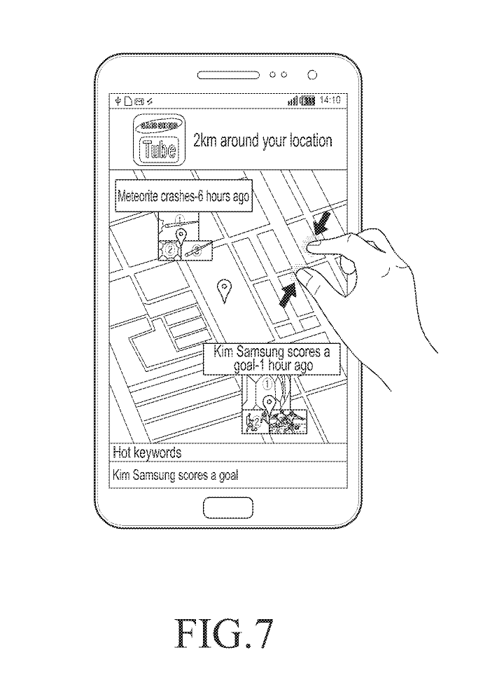

FIG. 7 illustrates an example of extending a displayed screen area using a zoom-out function according to an embodiment of the present disclosure.

The zoom-out function may be executed by the user's manipulation or automatically when no medium data items related to an event are present on the current screen. If the zoom-out function is executed to extend the displayed area (when the radius from the location of the portable terminal 210 is extended, for example, from 500 m to 800 m), the result of search on another event occurring in the added area may be further displayed.

In the figure, the event additionally displayed by the zoom-out function is regarding “Kim Samsung scoring a goal” and the thumbnail images of three searched medium data items are displayed for example.

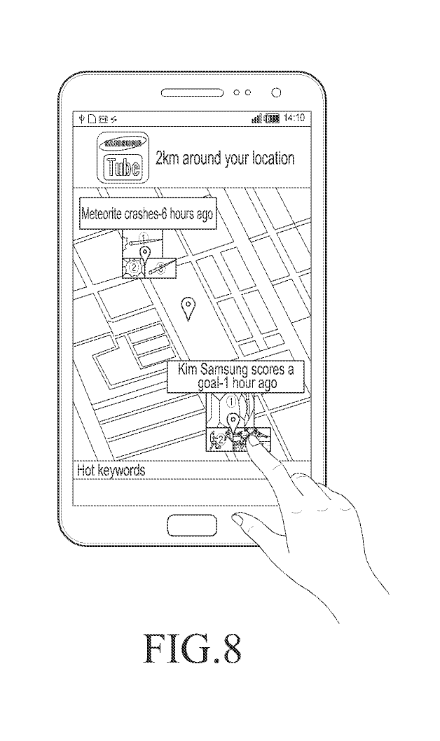

FIG. 8 illustrates an example of selecting medium data items searched corresponding to a particular event according to an embodiment of the present disclosure.

FIG. 8 illustrates an example in which among the displayed information corresponding to three medium data items collected in relation to “Kim Samsung scoring a goal”, the third medium data item is selected. For example, the user may select a medium data item desired to be played by touching one of the displayed information items on the screen. The displayed information item selected by the user for the selection may be a thumbnail image displayed on the screen corresponding to the searched medium data item.

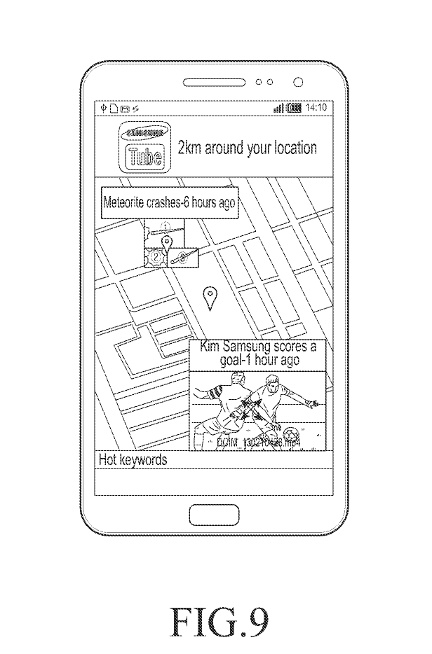

FIG. 9 illustrates an example of playing a selected medium data item through an auxiliary screen according to an embodiment of the present disclosure. The auxiliary screen may be a screen provided by a Picture in Picture (PIP) function. A functional icon requesting the medium data item being played through the auxiliary screen to be displayed on the full screen may be additionally displayed.

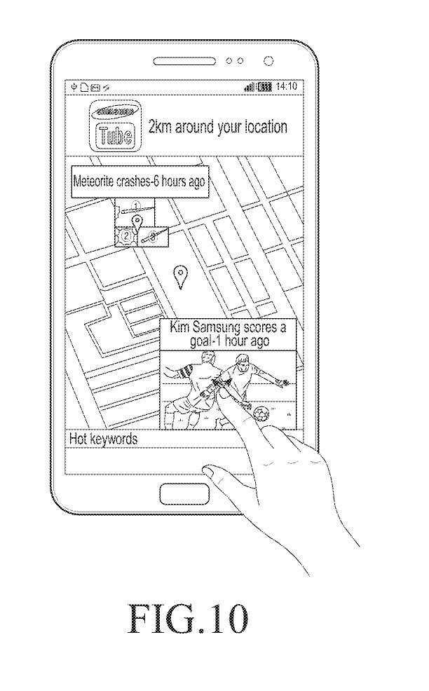

FIG. 10 illustrates an example of requesting to switch from the auxiliary screen on which the medium data item is being played to the full screen according to an embodiment of the present disclosure. As an example, the user may request switch to the full screen by selecting the auxiliary screen.

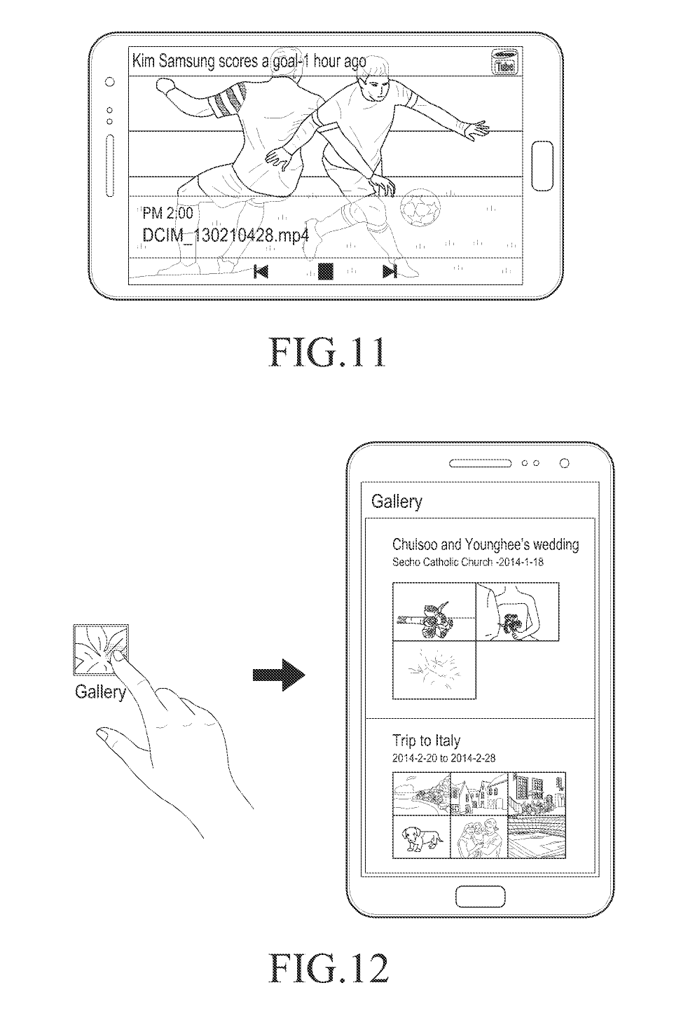

FIG. 11 illustrates an example of playing a selected medium data item through the full screen according to an embodiment of the present disclosure.

FIG. 12 illustrates an example of classifying medium data items collected per event in an internal storage medium according to an embodiment of the present disclosure.

Referring to FIG. 12, medium data items are collected based on the time and/or location information obtained for the event “Chulsoo and Younghee's wedding” and the collected medium data items are recorded and managed corresponding to the event “Chulsoo and Younghee's wedding”.

Medium data items are collected based on the time and/or location information obtained for the event “trip to Italy” and the collected medium data items are recorded and managed corresponding to the event “trip to Italy”.

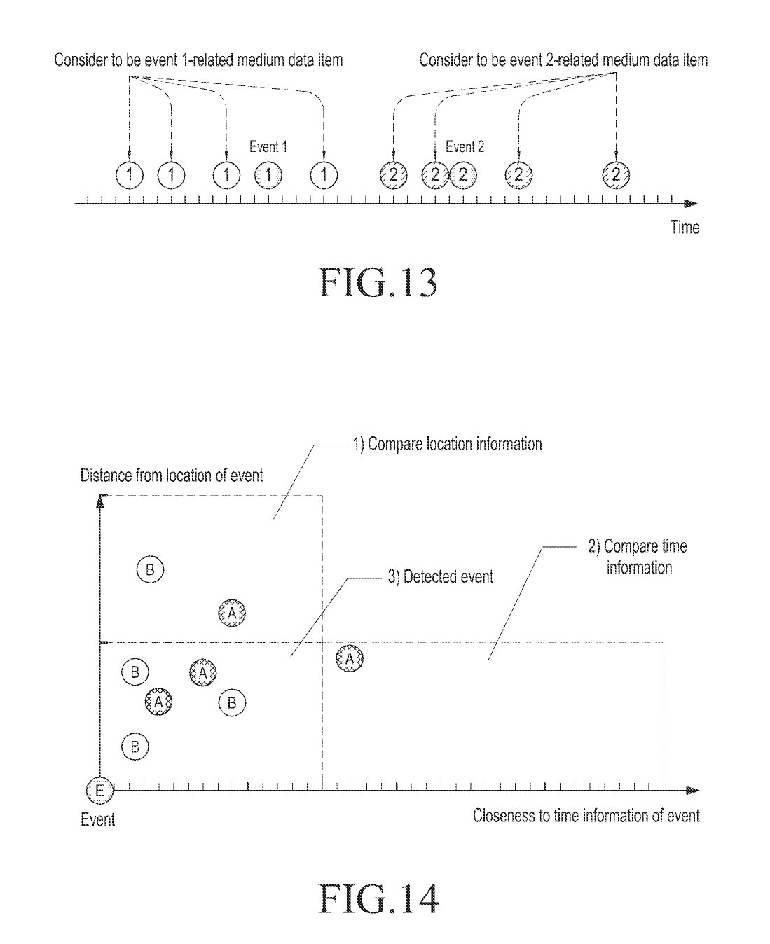

FIG. 13 illustrates an example of determining that a record is an event-related record in case there is a single recording entity according to an embodiment of the present disclosure.

Referring to FIG. 13, the occurrence time of event 1 is identified or predicted on the time axis, and records recorded at a time within a threshold range set on the time axis with respect to the occurrence time of event 1 identified or predicted may be considered as medium data items related to event 1.

Further, the occurrence time of event 2 is identified or predicted on the time axis, and records recorded at a time within a threshold range set on the time axis with respect to the occurrence time of event 2 identified or predicted may be considered as medium data items related to event 2.

FIG. 14 illustrates an example of determining that a record is an event-related record in case there are multiple recording entities according to an embodiment of the present disclosure. In FIG. 14, assume that there are two recording entities (circled A's and circled B's).

Referring to FIG. 14, it may be the distribution of records that have been recorded at the unique recording times and locations of the multiple recording entities with respect to the occurrence time and location of a particular event. In other words, each record may be located at particular coordinates with the recorded time and location. For example, at 1), location information of medium data items is compared with location information of the event to determine whether the medium data items are within the threshold distance from the location of the event. At 2), time information of the medium data items is compared with time information of the event to determine whether the medium data items are within a threshold time of the event. At 3), medium data items that are within both the location distance threshold and the time threshold are detected as being of the event.

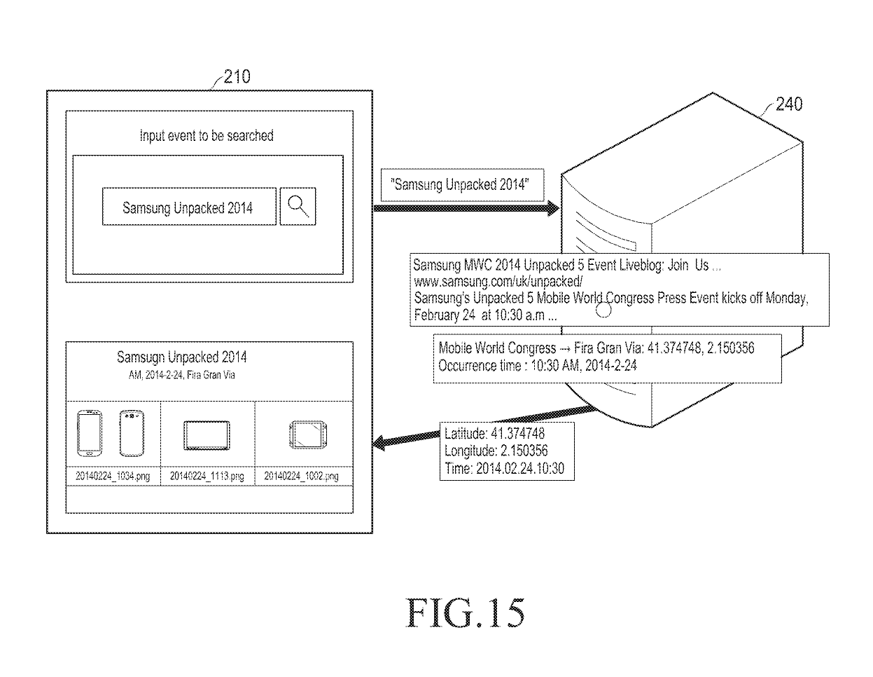

FIG. 15 illustrates an example of identifying the location and/or time information of an event using information provided from a third party according to an embodiment of the present disclosure.

Referring to FIG. 15, “Samsung Unpacked 2014” is input to the portable terminal 210 as an event to be searched. The portable terminal 210 provides the input “Samsung Unpacked 2014” to a searching server 240. The searching server 240 collects information related to the “Samsung Unpacked 2014” through a search on the “Samsung Unpacked 2014” and obtains the occurrence time and location information of the event “Samsung Unpacked 2014” from the collected information. Corresponding to the “Samsung Unpacked 2014”, the location information “Fira Gran Via” and the time information “10:30 AM, 2014-02-24” have been obtained.

The searching server 240 provides the obtained time and location information to the portable terminal 210. The searching server 240 may provide the obtained time and location information to the portable terminal 210 in a previously agreed format. As an example, the location information “Fira Gran Via” may be provided to the portable terminal 210 in a previously agreed format of latitude and longitude information (latitude: 41.374748, longitude: 2.150356), and the time information “10:30 AM, 2014-02-24” may be provided to the portable terminal 210 in a previously agreed format of “20140224_{—}1030”.

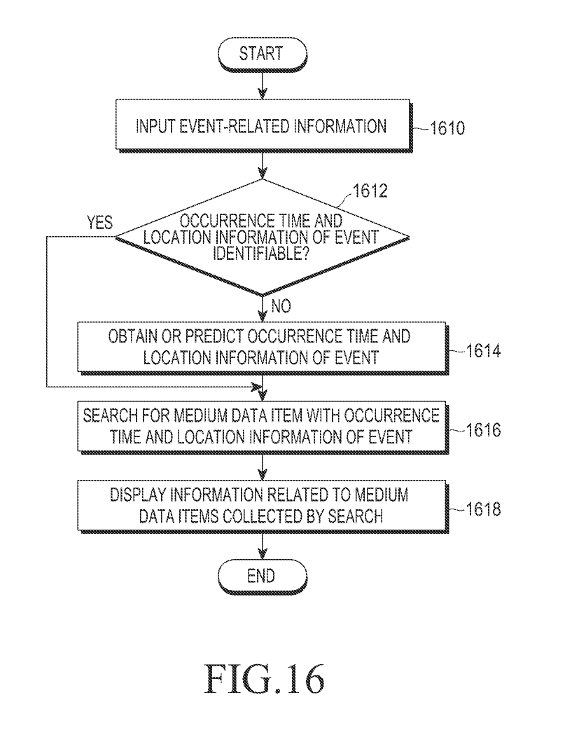

FIG. 16 illustrates a flow of control for searching for medium data items regarding a particular event by a portable terminal 210 according to an embodiment of the present disclosure.

Referring to FIG. 16, the portable terminal 210 receives event-related information at operation 1610. The event-related information is information for identifying an event for which medium data items are desired to be searched. The event-related information may include information that allows the place and/or time information of the event to be obtained or predicted. For example, an example in which the event-related information is constituted of event ID information is shown in FIG. 4, and an example in which the event-related information includes information that allows for prediction of the occurrence location of the event other than identifying the event is shown in FIG. 5. Besides, the input of the event-related information may be performed by selection of one medium data item regarding the particular event. As an example, in case a file name for a generated medium data item is created with the information on the data and time when the medium data item was recorded, the occurrence time information of the event may be obtained as the event-related information from the file name of the medium data item.

The portable terminal 210, at operation 1612, determines whether it is possible to identify the occurrence time and/or location information of the event from the received event-related information. An example of directly identifying the occurrence time and/or location information from the event-related information has been already described above.

If it is impossible to identify the occurrence time and/or location information of the event from the received event-related information, the portable terminal 210, at operation 1614, may obtain or predict the occurrence time and/or location information of the event using the received event-related information. The occurrence time and/or location information of the event may be obtained or predicted using the received event-related information by the example shown in FIG. 15. FIG. 15 illustrates an example of identifying the location and/or time information of an event using information provided from a third party.

Upon failure to obtain or predict the occurrence time and/or location information using the received event-related information, the portable terminal 210 indicates that it is impossible to search for medium data items related to the event. For example, the portable terminal 210 may display on the screen a message “failed to detect medium data items”.

Upon obtaining or predicting the occurrence time and/or location information of the particular event, the portable terminal 210, at operation 1616, searches for medium data items related to the particular event based on the recording time and/or location information of each medium data item recorded in the database and the occurrence time and/or location information of the event obtained earlier. The portable terminal 210 may compare the occurrence time and/or location information of the event with the recording time and/or location information of each recorded medium data item, and may search for medium data items related to the event according to the result of the comparison. For example, the portable terminal 210 searches for medium data items with recording times and/or locations present within a threshold range with respect to the occurrence time and/or location of the event as the medium data items related to the event.

If the medium data items meeting the conditions are searched, the portable terminal 210, at operation 1618, may display the information related to the collected medium data items. The collected medium data item-related information includes at least one of the recording time and/or location information of the medium data item. The recording location information may be defined by latitude and longitude information. In the case that a medium data item is a picture, the recording time information includes the time when the medium data item was filmed or recorded. In the case that a medium data item is a video, however, the recording time information may include the start time and end time of the filming or recording of the medium data item or the start time and duration of the filming or recording.

Examples of displaying the search result of the medium data items are shown in FIGS. 4 and 5.

Although not defined in the control flow shown in FIG. 16, the portable terminal 210 may change the displayed area after having displayed the search result on the screen or support an additional operation as a particular medium data item is selected. For example, as the area displayed on the screen is extended or shrunken by zoom-out or zoom-in, the portable terminal 210 may process and display the search result. An example thereof is shown in FIG. 7.

When a particular medium data item is selected from among the medium data items displayed on the screen as the search result, the portable terminal 210 displays or plays the selected medium data item on a small screen using the PIP function. An example thereof is shown in FIG. 8. When the medium data item is displayed or played on the small screen, the portable terminal 210 may additionally display an icon for a screen extending function on the screen. An example thereof is shown in FIG. 9.

When the small screen displayed or played is touched by the user, the portable terminal 210 extends the display or play of the medium data item to the full screen. An example thereof is shown in FIGS. 9 and 10.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for collecting a medium data item by a portable terminal, the method comprising:
collecting medium data items determined to be related to a particular event under a search condition according to an occurrence time of the particular event; and
classifying the collected medium data items records for the particular event.

2. The method of claim 1, further comprising obtaining at least one of the occurrence time of the particular event and an occurrence location of the particular event using information input in relation to the particular event or data recorded in relation to the particular event.

3. The method of claim 2, wherein the collecting comprises:
in a case where the collection of the medium data items has been set to a same recording entity, collecting at least one medium data item recorded at a time within a threshold range set with respect to the occurrence time of the particular event among the medium data items recorded by the same recording entity; and
collecting only medium data items recorded at a location within a threshold range set with respect to the occurrence location of the particular event from the at least one medium data item collected at the occurrence time,
wherein the threshold range with respect to the occurrence time of the particular event and the threshold range with respect to the occurrence location of the particular event are set according to a type of the particular event.

4. The method of claim 2, wherein the collecting comprises:
in a case where the collection of the medium data items has been set to multiple recording entities, collecting medium data items recorded at a location within a threshold range set with respect to the occurrence location of the particular event and at a time within a threshold range set with respect to the occurrence time of the particular event from among the medium data items recorded by the multiple recording entities,
wherein the threshold range with respect to the occurrence time of the particular event and the threshold range with respect to the occurrence location of the particular event are set according to a type of the particular event.

5. The method of claim 2, wherein the data recorded in relation to the particular event comprises information that allows for prediction of at least one of a time, location, and place where the particular event has occurred and comprises at least one of schedule information, a picture, and a video.

6. The method of claim 5, further comprising, upon predicting the place where the particular event has occurred using the data recorded in relation to the particular event, obtaining a latitude and longitude of the location where the particular event has occurred based on the information regarding the predicted place.

7. The method of claim 1, wherein the obtaining comprises transferring information input in relation to the particular event to an external server and receiving, from the external server, information regarding the occurrence time and occurrence location of the particular event according to the transferred information.

8. The method of claim 1, further comprising assigning information assigned to one of the medium data items collected for the particular event to other medium data items in a same manner.

9. A method for displaying a medium data item by a portable terminal, the method comprising:
predicting an occurrence time and location of a particular event for which medium data items are to be collected;
displaying information on at least one medium data item collected using the predicted time and location on an electronic map displayed on a screen with respect to a location where the particular event has occurred according to the predicted location; and
if the displayed information is selected, playing a medium data item corresponding to the selected information on the map.

10. The method of claim 9, further comprising:
extending an area of the map displayed on the screen in response to a zoom-out request for the map;
if an additional event is discovered on the extended area, collecting information on at least one medium data item using the predicted time and location regarding occurrence of the additional event; and
displaying information on at least one medium data item collected corresponding to the additional event on the area-extended map with respect to the location where the additional event has occurred.

11. An apparatus for collecting a medium data item, the apparatus comprising:
a communication module configured to provide a communication function through a network; and
a control module configured to collect medium data items determined to be related to a particular event under a search condition according to an occurrence time of the particular event and classify the collected medium data items records for the particular event.

12. The apparatus of claim 11, wherein the control module obtains the occurrence time of the particular event or an occurrence location of the particular event using data recorded in relation to the particular event or information input in relation to the particular event.

13. The apparatus of claim 12, wherein the control module, in a case where the collection of the medium data items has been set to a same recording entity, collects at least one medium data item recorded at a time within a threshold range set with respect to the occurrence time of the particular event among the medium data items recorded by the same recording entity, and collects only medium data items recorded at a location within a threshold range set with respect to the occurrence location of the particular event from the at least one medium data item collected at the occurrence time, and
wherein the threshold range with respect to the occurrence time of the particular event and the threshold range with respect to the occurrence location of the particular event are set according to a type of the particular event.

14. The apparatus of claim 12, wherein the control module, in a case where the collection of the medium data items has been set to multiple recording entities, collects medium data items recorded at a location within a threshold range set with respect to the occurrence location of the particular event at a time within a threshold range set with respect to the occurrence time of the particular event from among the medium data items recorded by the multiple recording entities, and
wherein the threshold range with respect to the occurrence time of the particular event and the threshold range with respect to the occurrence location of the particular event are set according to a type of the particular event.

15. The apparatus of claim 12, wherein the data recorded in relation to the particular event comprises information that allows for prediction of at least one of a time, location, and place where the particular event has occurred and comprises at least one of schedule information, a picture, and a video.

16. The apparatus of claim 15, wherein the control module, upon predicting the place where the particular event has occurred using the data recorded in relation to the particular event, obtains a latitude and longitude representing the location where the particular event has occurred based on the information regarding the predicted place.

17. The apparatus of claim 11, wherein the communication module, under the control of the control module, transfers information input in relation to the particular event to an external server and receives, from the external server, information regarding the occurrence time and occurrence location of the particular event extracted by the transferred information.

18. The apparatus of claim 11, wherein the control module assigns information assigned to one of the medium data items collected for the particular event to other medium data items in a same manner.

19. A portable terminal configured to display a medium data item, the portable terminal comprising:
a displaying unit; and
a control module configured to predict an occurrence time and location of a particular event for which medium data items are to be collected, display information on at least one medium data item collected using the predicted time and location on an electronic map displayed on a screen with respect to a location where the particular event has occurred according to the predicted location, and if the displayed information is selected, play a medium data item corresponding to the selected information on the map.

20. The portable terminal of claim 19, wherein the control module extends an area of the map displayed on the screen in response to a zoom-out request for the map, if an additional event is discovered on the extended area, collects information on at least one medium data item using the predicted time and location regarding occurrence of the additional event, and controls the displaying unit to display information on at least one medium data item collected corresponding to the additional event on the area-extended map with respect to the location where the additional event has occurred.
